(19) United States
(12) Patent Application Publication
(10) Pub. No.: US 2013/0036135 A1
(43) Pub. Date: Feb. 7, 2013

(54) CLOUD DATA STORAGE

(71) Applicants: Michael Brockey, Adamstown, MD (US); Steven Buxton, Ashburn, VA (US)

(72) Inventors: Michael Brockey, Adamstown, MD (US); Steven Buxton, Ashburn, VA (US)

(21) Appl. No.: 13/198,252

(22) Filed: Aug. 4, 2011

(51) Int. Cl. G06F 17/30

(52) U.S. Cl. 707/770; 707/E17.01

(57) ABSTRACT

Disclosed herein are systems, methods, and non-transitory computer-readable storage media for efficiently storing information. For example, lower-quality copies of files can be stored locally, and higher-quality, original versions of files can be stored on the Internet. Storing a lower-quality or lower-resolution version of a file locally can reduce local storage requirements. The higher-quality, or higher resolution, original version of a file can be retrieved from the cloud if the locally stored version is not of sufficient quality for a particular use. However, the lower-quality copy may be of sufficient quality for most usages.

### BACKGROUND

1. Technical Field

The present disclosure relates to data storage and more specifically to data storage on the Internet.

2. Introduction

With the creation of the world-wide-web and high-speed computer networks, the paradigm for personal computer usage has dramatically shifted. In the past, users would primarily use their personal computers to run programs, and store and manipulate data that was located on their local hard-drive. Only rarely would users store or manipulate data located on a networked drive, or run a program that was provided as a network service, and even then, the programs and data were usually restricted to a local area network. Today, more and more users are storing more and more data on remote data servers, and using remotely provided web-based applications (e.g., SaaS or Software as a Service programs) to manipulate and organize that data. For example, many users today store their personal email and contact information, and even pictures, videos, and music archives on remote servers, and access that data using third-party applications that are provided through and controlled by a web browser.

Cloud computing is a style of computing in which computing resources such as applications and file storage are remotely provided over the Internet, typically through a web browser. Many web browsers are capable of running applications (e.g., Java applets), which can themselves be application programming interfaces (“API's”) to more sophisticated applications running on remote servers. In the cloud-computing paradigm, a web browser interfaces with and controls an application that is running on a remote server. Through the browser, the user can create, edit, save and delete files on the remote server via the remote application. Various vendors, e.g., Amazon EC2, provide hosting for cloud-based services.

Storing data on the cloud can provide benefits of increased storage space, online backup and access to data from anywhere that there is an Internet connection. Currently, consumers use products for cloud-based data backup. These backup applications can copy a user's entire hard-disk, or certain directories or files, to the cloud so that in the event of a malfunction of a local disk, copies of the data can be recovered from the cloud.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Local storage space, e.g., on the hard-disk of a laptop, is continuously strained by the amount of information that consumers store. For example, digital media, e.g., photos, video and music, is constantly being stored in higher qualities such as high definition. Moreover, over time, hard-disks become cluttered with other file types such as documents and spreadsheets. Therefore, there is an ever-increasing need for additional storage space. The cloud can provide a cost-effective option for additional storage space by charging users a relatively small fee on a regular basis; another option being purchasing a second hard-disk and storing information locally. One benefit of storing information locally is that an Internet connection is not required to access the information and access to local data can be faster than downloading data from the Internet. Storing data on the cloud can have advantages for providing increased storage space, online backup in case of fire, and access to information anywhere there is an Internet connection.

An additional benefit is that the locally stored information may require fewer resources to process. In one example, a lower-resolution image can be rendered more quickly than a higher resolution image, thereby increasing the speed of image viewing, which can be important when quickly browsing through images, particularly on a resource-limited device, such as a smartphone. Embodiments of the present disclosure seek to provide both of the benefits of local and cloud storage.

Disclosed are systems, methods, and non-transitory computer-readable storage media for storing data on the cloud and on a local drive. Currently, users may use the cloud to store only the information that is on their local disk-drive, or use the cloud for additional storage beyond what they can store on their local computer. Embodiments of the present disclosure can allow for increasing storage space on a local hard-disk through compression, while storing a full-size file on the Cloud. This gives a user local access to data for quick retrieval without the need for an Internet connection. Also, a full-sized file is still available to the user on the cloud in case the user needs the full-size file. For example, a user can have more high-resolution images than can fit on their local hard disk. However, the user may only need high-resolution versions on rare occasions, if ever; for example, a high resolution image may be needed for a large-format print of an image. Quick viewing or display locally can be better accomplished using a lower-resolution image because fewer resources are required to render, open and store the lower-resolution image locally.

### BRIEF DESCRIPTION OF THE DRAWINGS

To describe the manner in which the above-recited and other advantages and features of the disclosure can be obtained, a more particular description of the principles briefly described above will be rendered by reference to specific embodiments thereof that are illustrated in the appended drawings. Understanding that these drawings depict only exemplary embodiments of the disclosure and are not therefore to be considered to be limiting of the scope of the disclosure, the principles herein are described and explained with additional specificity and detail through the use of the accompanying drawings in which:

FIG. 1 illustrates an example system embodiment;

FIG. 2 illustrates a diagram of inputting an original file into an application, generating a second file and storing the original file and the second file;

FIG. 3A illustrates a flowchart in accordance with an exemplary embodiment, for generating and storing a second file;

FIG. 3B illustrates a flow chart in accordance with an exemplary embodiment, for retrieving an original file; and

FIG. 4 illustrates an image viewing application in accordance with one embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

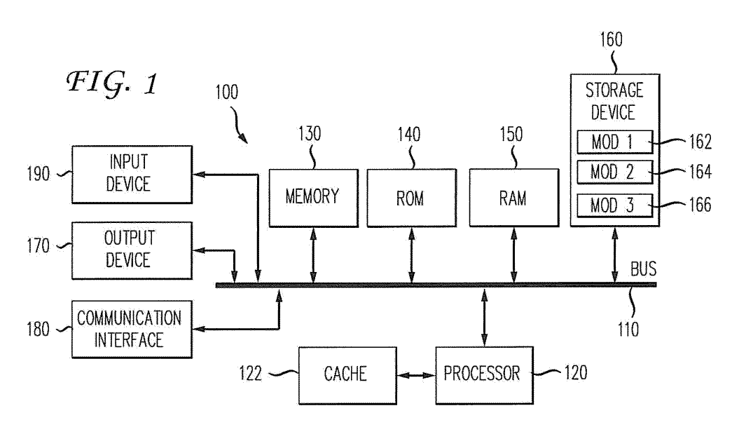

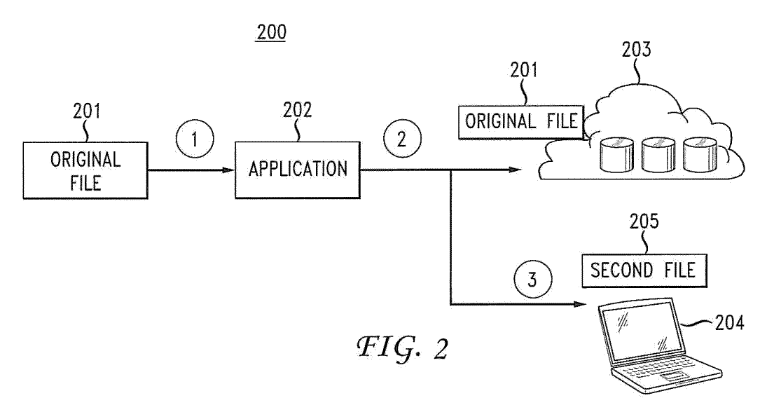

The present disclosure addresses the need in the art for both the benefits of cloud storage and local storage. A system, method and non-transitory computer-readable media are disclosed which allow for both the benefits of cloud storage and local storage. A brief introductory description with reference to FIG. 2 will be provided, followed by a discussion of a basic general-purpose system or computing device in FIG. 1 that can be employed to practice the concepts disclosed herein. A more detailed description of methods and graphical interfaces will then follow.

FIG. 2 illustrates a basic diagram of an embodiment of the present disclosure. More specifically. FIG. 2 illustrates an original file 201 being received by an application. Original file 201 can be any type of file as is known in the art (e.g., images, videos, games, documents, audio, presentations etc.) Once original file 201 is received by application 202, a second file 205 related to, and smaller than, the first file can be automatically generated. Second file 205 can be smaller than original file 201 in that second file 205 comprises fewer bits than original file 201, thereby requiring less storage space than original file 201. Second file 205 can be related to original file 201 in that it can be, for example, a lower-quality version of original file 201, or second file 205 could comprise instructions for how to retrieve original file 201. Second file 205 can be a modified, compressed or substitute version of original file 201; what is important is that second file 205 is a related to, and smaller than, original file 201. In the case that original file 201 is an image, second file 205 can be a reduced-resolution copy of original file 205, thereby generating a second file 205 related to, and smaller than, original file 201 requiring fewer bits to store the image. In another example, original file 201 can be a video; second file 205 could be, for example, a poster frame of the original video, thereby generating a second file 205 related to, and smaller than, original file 201 and greatly reducing the number of bits needed to store a representation of original file 201. In a second embodiment of generating a second file 205 that is related to, and smaller than, original video file 201, a second video file 205 can be created; the second video file 205 can be a clip or clips from the original video 201, or the second video file 205 can include instructions for how to retrieve the original video file 201. Original video 201 can be stored on one or more remote databases 203. Additionally, the second file 205 related to, and smaller than, original file 201 can be locally stored, for example, on a laptop 204. Laptop 204 could be substituted for any other local storage such as a Network-Attached Storage (NAS), smartphone, digital media device, desktop computer, etc.

It should be noted that some embodiments can include generating more files than just second file 205. For example, additional files, e.g., third, fourth, and more files, could be generated, which could be different, reduced-size copies of original file 201; some or each of the additional files could be copies of second file 205. The additional files could be automatically stored on separate devices. For example, it may be desirable to archive original file 201 in the cloud in the event that original file 201 is needed; second file 205 could be stored on a laptop; a third file, perhaps even smaller than second file 205, could be stored on a smaller-form-factor device such as a smartphone; and a fourth file, perhaps identical to second file 205, could be stored on the local storage of a smart television device, such as Apple® TV. Application 202 can provide a user with options for which devices to store files to and what types of files to store in accordance with the embodiments described herein.

The step of receiving original file 201 and generating second file 205 can be accomplished in a variety of ways. For example, a user can import the message into an application running on the user's computer or an application running on the cloud. The application can then generate second file 205 by, for example, compressing original file 201 or providing a reduced-size placeholder for original file 201. As described above, second file 205 can be a representation of the original file 201, and not necessarily a reduced-resolution copy of original file 201. However, second file 205 is more than a pointer or link to original file 201 stored on the one or more databases 203. Second file 205 can comprise, for example, a reduced-resolution copy of original file 201, or a description of how original file 201 can be retrieved. In the event that second file 205 is an image, second file 205 can also include a watermark to remind the user that larger version of second file 205 is available on the Internet. After original file 201 is uploaded and second file 205 is stored on a user device, then original file 201 can be deleted from the local storage, thus freeing up space on the local storage.

To import the images, the user can drag-and-drop a representation of an image or images into a folder or to an icon, this instructs the device 204 to upload the image to the cloud, or databases 203. If a user drags-and-drops an image or images that have already been uploaded, then the full version of the image can be downloaded, or the instruction to upload can be ignored.

Receiving original file 201 can cause second file 205 to be automatically generated by application 201 and stored in databases 203, or a user can be provided a plurality of options and requests for verification of what the user desires. In another embodiment, options for uploading the files can include an option for varying the size of second file 205. For example, the compression rate for second 205 can be given. Other options can determine whether a watermark should appear on the local image, what the watermark should be, where to store second file 205 that is related to, and smaller than, original file 201, etc.

These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high-speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general-purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially, be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, and 166 for controlling the processor 120. Other hardware or software modules are contemplated. The storage device 160 is connected to the system bus 110 by a drive interface. The drives and the associated computer-readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general-purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general-purpose DSP circuit, may also be provided.

The logical operations of the various embodiments are implemented as: (1) a sequence of computer-implemented steps, operations, or procedures running on a programmable circuit within a general-purpose computer, (2) a sequence of computer-implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

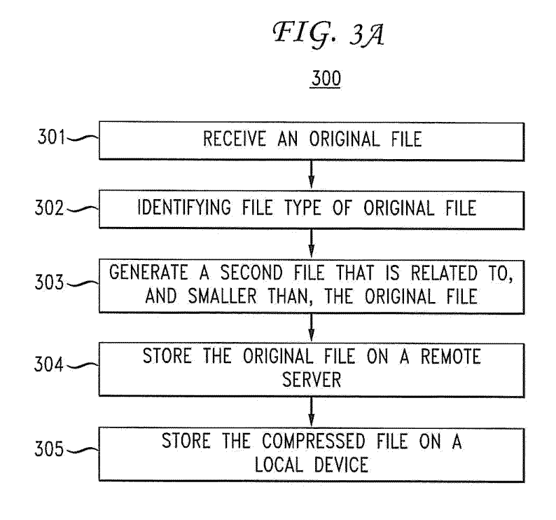

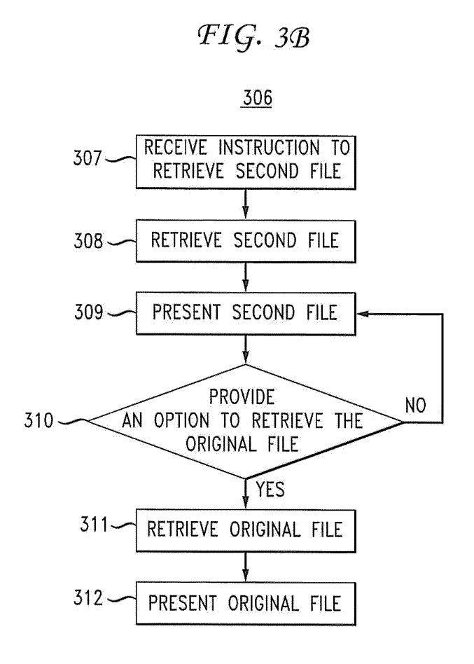

FIG. 3 illustrates an exemplary flowchart 300 in accordance with one embodiment of the present disclosure. Step 301 illustrates receiving an original file 201. Original file 201 can be received at a user device such as a smartphone, personal computer, etc.; or remote server etc. Step 302 illustrates identifying the file type of the original file 201, which can be used in the step 303 to generate second file 205. Original file 201 can be further received at an application 202 on the user device or remote server that can then generate second file 205 that is related to, and smaller than, original file 201 (step 303). The file type, identified in step 302, can be important in to ensure that second file 205 is of the same file type as original file 201. More specifically, if original file 201 is a video, second file 205 can be a video with instructions for retrieving original video file 201. Then it can be important to ensure that the original video and the instructions are of the same file type because otherwise the player application that plays the video may not be able to play the instructions. The instructions may not be playable because when the player application attempts to open a file of the type of the original file 201, but second file 205 is a different file type; the player application can fail because the expected file type is different from the file type of the second file 205. Some embodiments that compress original file 201 to generate second file 205 can allow the user to choose a compression ratio; for example, in the case of an image file, users that have fewer storage resources may choose a larger compression ratio, while users with a relatively large amount of storage may choose a smaller compression ratio. Additionally, options for compression rates on multiple devices can be provided. In one embodiment, the resolution of a user's display can be chosen as a target resolution for an image, thereby providing a user with a smaller image with an appearance that would be similar to that of a higher-resolution image because the screen size of the user's display might only support a smaller resolution.

Continuing on, step 304 illustrates storing the original file 203 on a remote server having databases 203. Storing original file 201 on databases 203 enables the user to access original file 201 in case a higher-quality version is desired. Concomitant with storing original file 201 on databases 203, a validation step can be performed to validate that original file 201 and the uploaded file are identical and not corrupted. Step 305 illustrates storing the second file 205 on a local device 204 (step 305). A local device 204 can be a device that the user frequently accesses, such as a personal computer or smartphone, thus giving the user quick access to second file 205. Second file 205 requires less storage space than original file 201, thus enabling storage of more files than if original file 201 was stored locally.

Once second file 205 and original file 201 are stored, the user may want to retrieve original file 201 from the Internet. FIG. 3B illustrates steps 306 to retrieve original file 201. Step 307 illustrates receiving an instruction to retrieve second file 205. This can be accomplished by, for example, selecting second file 205 from a file directory or media application, such as iTunes® or iPhoto®. Next, step 308 illustrates retrieving second file 205 from local storage on device 204. Step 309 illustrates presenting second file 205, which can comprise displaying an image or video and playing audio. In the case of an image file, presenting can comprise displaying the lower-resolution image. In the case of a video, a lower-resolution video can be played or a video comprising instructions can be played. Step 310 illustrates providing the user an option to the original file 201 from databases 203. The option can be given, for example, through a separate application, or integrated with the application that displays or plays second file 205. In some embodiments, an option can be automatically provided to a user before presenting second file 205. In other embodiments, the option can be provided to the user via application 202 on a second device, such as a smartphone. For example, if a user desires to view a video, but only the instructions for viewing original video 201 are stored locally, then an option can be provided to the user, via the smartphone, to initiate a download to a local storage on device 204, where it can then be used for viewing on a larger screen, such as a TV. Finally, depending on a user's choice, original file 201 can be retrieved (step 311) and presented to the user (step 312), or only second file 205 will be presented (step 309).

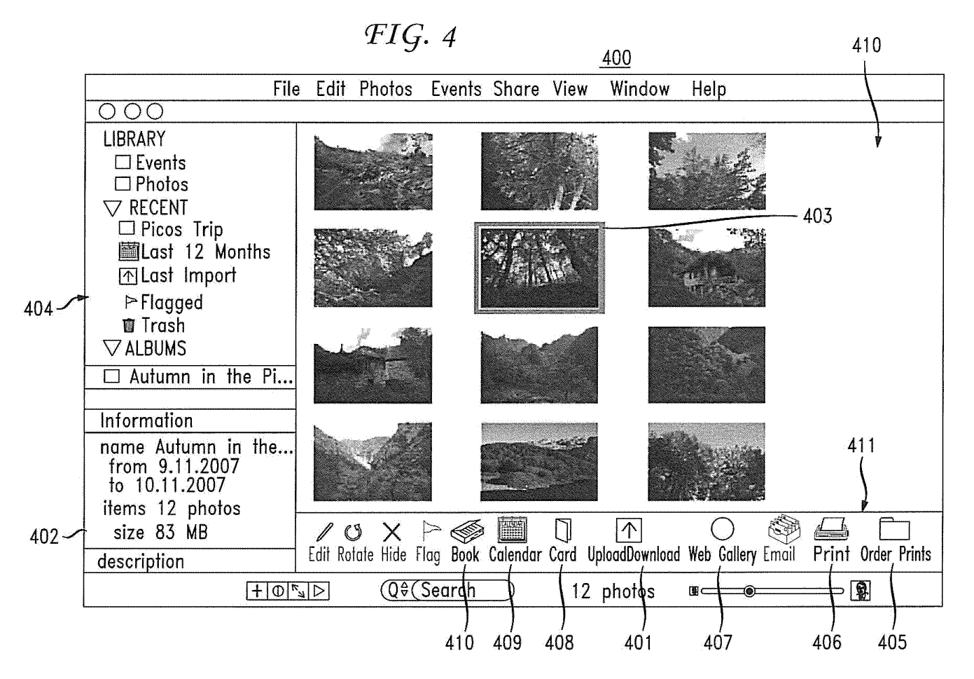

FIG. 4 illustrates an exemplary image application 400 that can be used in accordance with an exemplary embodiment. Image application 400 comprises an image viewing window 410 having several images, including a currently selected image 403. Side pane 404 can contain a plurality of image information 402, such as album name, image title, image comments, image date and the like. Additionally, navigation information, or any other information as is known in the art, could appear in side pane 404. Below image viewing window 410, can be a navigation menu 411. Navigation menu 411 can comprise several navigation options or applications for a user to use in conjunction with image application 400. For example, navigation menu 411 can comprise an option to upload/download 401 for uploading an image to the cloud-based application, as discussed in the embodiments above. In addition, options for viewing or printing images can be included: books 410, calendar 409, card 408, web gallery 407, print 406 and order prints 405. In some instances, the images stored locally can have a watermark to signify that a higher-resolution version is available in the cloud, or the locally stored image may have insufficient resolution for printing. Therefore, option to upload/download 401 can be used to download the higher-quality version for use in generating a high-quality printout of the image. More specifically, if, for example, currently selected image 403 has a corresponding higher-quality versions stored on the cloud, image 403 could be dragged-and-dropped to option to upload/download 401 to begin a download of the higher; quality version in preparation of printing the image.

In additional embodiments, option to upload/download 401 can include an option to synchronize the local images with the images stored on the cloud. This synchronization can occur in either direction. For example, a user may want to remove images from databases 203 that no longer have corresponding locally stored images. In addition, if a user previously deleted lower-quality, locally stored images, the user can download lower-resolution copies of images stored on databases 203. When this synchronization or rebuilding of the locally stored and cloud-stored images is occurring, thumbnails can be generated in a temporary directory to ensure that duplicate copies are not generated during the synchronization process. In other words, the thumbnails can be used to identify an image as having been synchronized. These thumbnails can be deleted after the synchronization process completes.

Some embodiments can include an auto-syncing feature. In these embodiments, an album, directory or folder can be set to auto-sync any files stored in that folder to the Internet. When an album, directory or folder is configured for auto-syncing, all files within that folder can be automatically stored to the Internet. Files subsequently added to the folder can remain in the folder for a configurable time period (e.g., one week or month), and after the configurable time period has expired, the file can be stored to the Internet. One reason to keep a file locally for the configurable time period is that a user may have just uploaded an image to the directory, and may want to have the full version for temporary use, and the image can be archived to the Internet, with a second file 205 stored locally thereafter.

In still further embodiments, instead of providing option to upload/download as a button or icon in an application, an option to upload/download can be provided in a menu integrated with an operating system, such as the start menu of Windows® or the menu bar of Mac™ OS.

Embodiments described in detail above include video and images; however, other embodiments are contemplated using any other file type that can be made smaller. For example, a document file for editing may contain a lot of information used for editing, revising or manipulating the document. Much of this information is not necessary for simply viewing the document. For example, a .doc file, compatible with Microsoft® Word®, can be made smaller by, for example, removing metadata, formatting, color, etc. Spreadsheets can be made smaller in a similar fashion. In other embodiments, music files can be made smaller by using lower sampling frequencies; for example, a file sampled at 320 Kbps can be lowered to a sampling frequency of, e.g., 128 Kbps. The lower-quality file can be satisfactory for playback via headphones, but not for a home stereo. Therefore, providing an option for how a file is made smaller, e.g., compressed, can be more important in the context of music files.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general-purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be used to generate second files that are related to, and smaller than, an original file of many file types, and storing the original file on a remote server. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving an original file at an application running on one of a device and a remote server;
generating, via a processor of the device or the remote server, a second file related to, and smaller than, the original file;
storing the second file on the device; and
storing the original file on the server.

2. The method of claim 1, wherein the original file is an image file.

3. The method of claim 2, wherein the second file is a reduced-resolution copy of the original file.

4. The method of claim 1, wherein the original file is a video file.

5. The method of claim 4, wherein the second file is a video file explaining how to retrieve the original file.

6. The method of claim 1 further comprising: receiving an instruction from a user to download the original file.

7. The method of claim 6, wherein the instruction is received from a second device and the original file is downloaded to the device.

8. A system comprising:
a device comprising a processor and a storage;
a first module configured to control the processor to receive an original file;
the first module further configured to generate a second file related to, and smaller than, the original file;
the first module further configured to upload the original file to a server; and
the server configured to receive the file, wherein the second file is stored in the storage and the original file is stored in the server.

9. The system of claim 8, wherein the original file is an image file.

10. The system of claim 9, wherein the second file is a reduced-resolution copy of the original file.

11. The system of claim 9, wherein the original file is a video file.

12. The system of claim 11, wherein the second file is a video file explaining how to retrieve the original file.

13. The system of claim 8 further comprising: receiving an instruction from a user to download the original file.

14. The system of claim 13, wherein the instruction is received from a second device and the original file is downloaded to the device.

15. A non-transitory computer-readable storage medium storing instructions, the instructions comprising:
receiving an original file at a computing device;
generating a second file related to, and smaller than, the original file;
storing the second file on the computing device; and
uploading the original file to a server on the Internet.

16. The non-transitory computer-readable storage medium storing instructions of claim 15, wherein the original file is an image file.

17. The non-transitory computer-readable storage medium storing instructions of claim 16, wherein the second file is a reduced-resolution copy of the original file.

18. The non-transitory computer-readable storage medium storing instructions of claim 15, wherein the original file is a video file.

19. The non-transitory computer-readable storage medium storing instructions of claim 18, wherein the second file is a video file explaining how to retrieve the original file.

20. The non-transitory computer-readable storage medium storing instructions of claim 15, the instructions further comprising: providing an option for varying the size of the second file.
